(19) United States
(12) Patent Application Publication
(10) Pub. No.: US 2005/0062707 A1
(43) Pub. Date: Mar. 24, 2005

(54) Matrix addressing method and circuit, and liquid crystal display device

(76) Inventors: Masakatsu Yamashita, Kobe-shi (JP); Masayuki Ikehara, Kobe-shi (JP)

Correspondence Address: Philips Electronics North America Corporation;Corporate Intellectual Property, 1000 West Maude Avenue, Sunnyvale, CA, 94085, US

(21) Appl. No.: 10/490,981

(22) PCT Filed: Sep. 27, 2002
(86) PCT No.: PCT/IB02/04011

(30) Foreign Application Priority Data
Sep. 28, 2001 (JP) 01-302580

(51) Int. Cl. G09G 3/36

(52) U.S. Cl. 345/96

(57) ABSTRACT

The invention aims at reducing power consumption without sacrificing advantages of an alternately driving method in the prior art. A matrix addressing circuit for alternately driving pixels arranged in matrix, wherein: a plurality of row electrodes extending in a horizontal direction of a display screen are made to be selectively active for each horizontal scanning period of images to be displayed; a plurality of column electrodes extending in a vertical direction of the display screen are applied with respective pixel voltages that are responsive to the image and correspond to the horizontal scanning period while the pixel voltages have polarities alternating for each frame period of the images; and the pixel voltages have polarities alternating in the vertical direction spatially in a display area within the frame period. This matrix addressing circuit comprising: time-series operating means (30, 40) for successively sequencing on a time series an application timing of the pixel voltages for one row electrode and an application timing of the pixel voltages for the other row electrode, the pixel voltages for the other row electrode being to be in the same polarities as the pixel voltages for the one row electrode; and row driving means (30, 60) for activating the corresponding row electrode in response to each of the application timings of the pixel voltages for the one and the other row electrode.

### BACKGROUND OF THE INVENTION

1. Field of the Invention

The present invention relates to matrix addressing method and circuit for driving pixels arranged in form of rows and columns or in form equivalent thereto (hereinafter, simply referred to as in matrix) in accordance with an image to be displayed. More particularly, the present invention relates to the so-called alternately driving method for matrix display devices.

2. Description of Related Art

Conventionally, many active matrix type liquid crystal display devices use the so-called alternately driving method. This method is countermeasures against the phenomenon of deterioration in which the properties of liquid crystal material change, the resistivity of the material decreases, and so on when the liquid crystal is driven with DC voltages, which is intended to invert the polarities of driving voltages applied to the liquid crystal every frame. The basic operation in the method is disclosed in more detail on pages 69 to 74 of a book titled as “Liquid Crystal Display Technology—ActiveMatrix LCDs—” written by Shoichi MATSUMOTO, published on Nov. 14, 1997, for example in the second printing by Sangyo Tosho, Co., Ltd.

Since the frequency of reversing polarities of the driving voltages is ½ of the frame frequency, flicker is caused basically. However, in such a type of alternately driving method, the fundamental component of the optical response ripple is rendered in the frame frequency or more by spatially and temporally averaging the polarity inversion within a display screen so as to prevent the flicker (visible flicker). More specifically, with respect to any one pixel, a polarity(ies) of the driving voltage(s) for the next pixel(s) (or the next row or column of pixels) is (are) made differed, and these polarities are reversed every frame.

The present inventors have found that there is a problem that in the above-mentioned prior art, a polarity reversion rate of the driving voltage is high and therefore a driving circuit tends to require much more power consumption.

### SUMMARY OF THE INVENTION

The present invention is devised in consideration of the above description, and its object is to provide matrix addressing method and circuit, and a liquid crystal display device using it, which can reduce the power consumption.

It is another object of the present invention to provide matrix addressing method and circuit, and a liquid crystal device using it, which can reduce the power consumption without sacrificing advantages of an alternately driving method in the prior art.

It is a further object of the present invention to provide matrix addressing method and circuit, and a liquid crystal display device using it, which contribute to increase of the variety of an alternately driving method, and which can reduce the power consumption by using the technique of electronic circuits such as memory or the like.

In order to accomplish the above-mentioned objects, according to one aspect of the present invention, there is provided a matrix addressing method for alternately driving pixels arranged in matrix, wherein: a plurality of row electrodes extending in a horizontal direction of a display screen are made to be selectively active for each horizontal scanning period of images to be displayed; a plurality of column electrodes extending in a vertical direction of the display screen are applied with respective pixel voltages that are responsive to the image and correspond to the horizontal scanning period while the pixel voltages have polarities alternating for each frame period of the images; and the pixel voltages have polarities alternating in the vertical direction spatially in a display area within the frame period, the method including: successively sequencing on a time series an application timing of the pixel voltages for one row electrode and an application timing of the pixel voltages for the other row electrode, the pixel voltages for the other row electrode being to be in the same polarities as the pixel voltages for the one row electrode; and activating the corresponding row electrode in response to each of the application timings of the pixel voltages for the one and the other row electrodes.

The matrix addressing method may be characterized by by a first time-series operation process and a second time-series operation process each of which is carried out at least once, the first time-series operation process being a process whereby an application timing of the pixel voltages for one row electrode to be given the first polarities and an application timing of the pixel voltages for the other row electrode to be given the first polarities are in succession, the second time-series operation process being a process whereby an application timing of the pixel voltages for further one row electrode to be given the second polarities different from the first polarities and an application timing of the pixel voltages for the other row electrode to be given the second polarities are in succession, wherein the corresponding electrode is activated in response to each of the application timings of pixel voltages for the row electrodes.

The pixel voltages may have polarities that alternate in the vertical direction spatially in a display area within the frame period in units of at least one row electrode.

The pixel voltages may have polarities that alternate in the horizontal direction spatially in a display area within the frame period in units of at least one column electrode.

Also, in the first and second time-series operation processes, an application timing of pixel voltages for a preceding row electrode to be given first polarities may be separated on a time series from an application timing of pixel voltages for a further row electrode to be given the other polarities, the further row electrode adjoining upward to the preceding row electrode spatially in a display area within the frame period.

Furthermore, in the first and second time-series operation processes, an application timing of pixel voltages for a preceding row electrode to be given first polarities may be separated on a time series from an application timing of pixel voltages for a further row electrode to be given the other polarities, the further row electrode adjoining downward to the preceding row electrode spatially in a display area within the frame period. Or, in the first and second time-series operation processes, an application timing of pixel voltages for a preceding row electrode to be given first polarities may be separated on a time series from an application timing of pixel voltages for a further row electrode to be given the other polarities, the further row electrode adjoining to the preceding row electrode spatially in a display area within the frame period.

Thanks to these, it is possible to reduce a temporal polarity reversion rate of the pixel voltage and to maintain the conventional alternating operation with regard to a spatial polarity reversion style of the pixel voltages on the screen. Therefore, it can overcome the existing state in which the polarity reversion rate is high and the large power consumption is required, the power consumption being reduced by lowering the temporal polarity reversion rate, the original advantages of the alternately driving system being offered at the same time.

In order to achieve the above-mentioned objects, according to another aspect of the present invention, there is provided a matrix addressing circuit for alternately driving pixels arranged in matrix, wherein: a plurality of row electrodes extending in a horizontal direction of a display screen are made to be selectively active for each horizontal scanning period of images to be displayed; a plurality of column electrodes extending in a vertical direction of the display screen are applied with respective pixel voltages that are responsive to the image and correspond to the horizontal scanning period while the pixel voltages have polarities alternating for each frame period of the images; and the pixel voltages have polarities alternating in the vertical direction spatially in a display area within the frame period, the matrix addressing circuit comprising: time-series operating means for successively sequencing on a time series an application timing of the pixel voltages for one row electrode and an application timing of the pixel voltages for the other row electrode, the pixel voltages for the other row electrode being to be in the same polarities as the pixel voltages for the one row electrode; and row driving means for activating the corresponding row electrode in response to each of the application timings of the pixel voltages for the one and the other row electrode.

In the matrix addressing circuit, the time-series operating means comprise: a memory for storing a data train signal representing the corresponding pixel voltages for each of pixel information blocks each corresponding to a row electrode; and a control circuit for executing reading out control of the memory, the control circuit controlling the reading of the memory to produce a modified data train signal in such a form that application timings of pixel voltages for one row electrode and of pixel voltages for the other row electrode to be given the same polarities as those of the pixel voltages for the one row electrode are successively sequenced on a time-series, from the data train signals stored in the memory, the row driving means are arranged to produce a row driving signal for activating the corresponding row electrode in response to each of the application timings of the pixel voltages for the one and the other row electrodes in harmony with the modified data train signals.

The addressing circuit may be arranged to drive an active matrix type display device comprising: pixel drive elements provided in association with pixels, whose control inputs are coupled with the row electrodes and whose signal inputs are coupled with the column electrodes; and a common electrode disposed facing pixel electrodes coupled to the pixel drive elements, and the addressing circuit may further comprise voltage producing means for producing a driving voltage signal to be applied to the common electrode, the driving voltage signal having polarity alternation adapted to the polarities to be given to the corresponding pixel voltages in response to each of the application timings of the pixel voltages for the one and the other row electrodes.

The present invention also provides a liquid crystal display device using the above-mentioned matrix addressing circuit.

### BRIEF DESCRIPTION OF THE DRAWINGS

FIG. 1 is a block diagram showing a schematic structure of a matrix addressing circuit according to one embodiment of the present invention.

FIG. 2 is a time chart showing an operation style of the addressing circuit in FIG. 1.

FIG. 3 is a schematic illustration showing distribution of driving polarities for pixels within a display screen in two frames, which means driving patterns of a one-line alternately-driving system.

FIG. 4 is a time chart showing an operation style of a matrix addressing circuit in the prior art for explaining advantages of the present invention.

FIG. 5 is a time chart for explaining one modification of the embodiment in FIG. 2.

FIG. 6 is a time chart for explaining the other modification of the embodiment in FIG. 2.

FIG. 7 is a time chart for explaining a further modification of the embodiment in FIG. 2.

FIG. 8 is a schematic illustration showing distribution of driving polarities for pixels within a display screen in two frames, which means driving patterns of a dot alternately-driving system.

### DESCRIPTION OF THE PREFERRED EMBODIMENT(S)

Hereinbelow, embodiments of the present invention will be described in more detail with reference to the accompanying drawings.

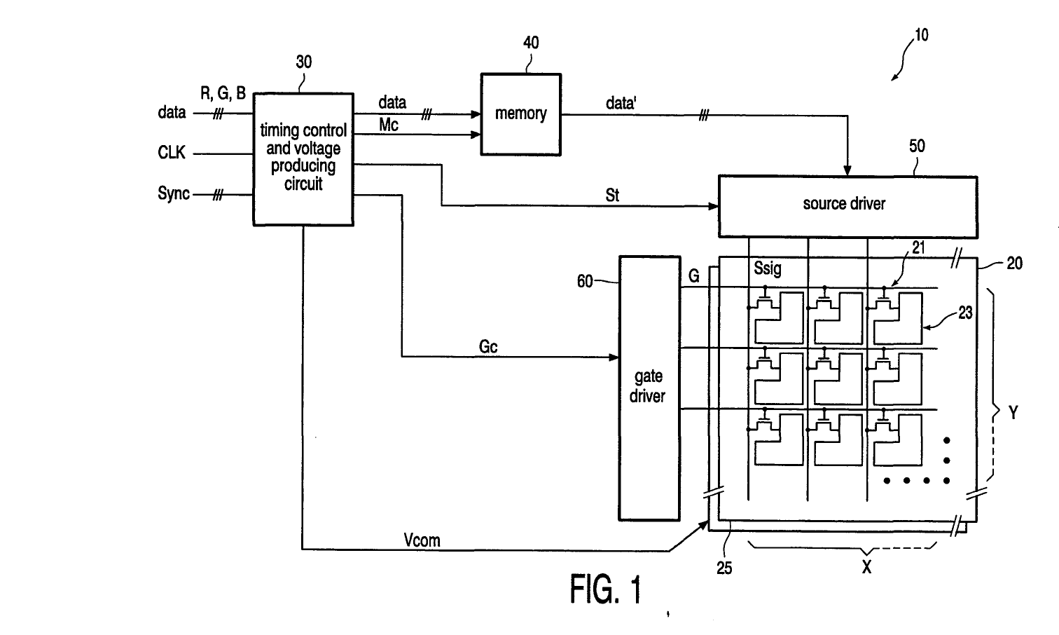

FIG. 1 shows a schematic structure of a matrix addressing circuit in a liquid crystal display device according to one embodiment of the present invention.

Referring to FIG. 1, a matrix addressing circuit 10 is arranged to drive a display panel 20 of an active matrix type liquid crystal display (LCD) device which has, for example, field-effect type thin film transistors (TFTs) 21 as active elements for driving pixels arranged in correspondence with the respective pixels within a predetermined display area.

In the display panel 20, the TFTs 21 have a matrix arrangement of Y rows and X columns. Gate electrodes of the TFTs 21 are connected for each row to a gate bus line which runs in parallel with a horizontal direction of the display area. Source electrodes of the TFTs 21 are connected for each columns to a source bus line which runs in parallel with a vertical direction of the display area. Drain electrodes of the TFTs 21 are individually connected to pixel electrodes 23 and the individual pixel areas are basically demarcated by these pixel electrodes.

The display panel 20 also has a common electrode 25 disposed in the face of the pixel electrodes with a gap. The gap is sealed with a liquid crystal medium (not shown). Herein, the common electrode 25 extends throughout a whole of the display area. The TFTs 21 are selectively turned on for each row by a gate control signal which is supplied via the gate bus line, while the turned-on TFT 21 is made to be at a drive-state according to the pixel information depending on the level of a source signal as a pixel voltage or a pixel signal which is supplied to the turned-on TFT 21 via its source bus line. The pixel electrode 23 is given a potential according to the drive-state by means of the drain electrode. The orientation of the liquid crystal medium is controlled for each pixel electrode by an electric field having a strength which is determined depending on the difference between a potential of the pixel electrode and a level of voltage supplied to the common electrode 25. Therefore, the liquid crystal medium can modulate back irradiation light from a back light system (not shown) and the external light from the front side for each pixel in accordance with the pixel information. Since the details of the above-mentioned liquid crystal display panel are well known from various literature, it is not described anymore in this section.

The matrix addressing circuit 10 has a basic constitution comprising a timing control and voltage producing circuit 30 as a front-stage circuit thereof, a memory 40 for storing image data, a source driver 50 as column driving means, and a gate driver 60 as row driving means.

The timing control and voltage producing circuit 30 receives image data signals “data” for red (R), green (G) and blue (B) from signal supplying means (not shown), a dot clock signal CLK, synchronization signals SYNC including horizontal and vertical synchronization signals. Then it transfers the image data signals to the memory 40, and produces memory control signal Mc for controlling the memory 40, a latch signal St for synchronously operating the source driver 50, and a control signal Gc for controlling the gate driver 60. The circuit 30 also produces a voltage signal V_{com} which is applied to the common electrode 25 in the display panel 20. In addition, the circuit 30 produces and supplies a reference voltage and the like which are used in the source driver 50 and the gate driver 60, but the description thereof is omitted for the sake of clarity.

The memory 40 receives the image data signals for R, G and B from the circuit 30, and sequentially stores them for each color on a horizontal scanning period basis. And at the same time it performs data processing (time-series operating process, featured by the present invention, described later) based on the memory control signal from the circuit 30. The data-processed image data signal “data” is transferred to the source driver 50.

The source driver 50 comprises digital-to-analog converters of the respective image data signals “data” for R, G and B, to convert each of the image data signals into analog signals every horizontal scanning period so as to produce pixel signals for each color, the pixel signals serving as pixel information pieces to be displayed for one horizontal scanning period (namely, one line of pixel information). These pixel signals are held until the next horizontal scanning period, and are supplied to the corresponding source bus lines. Incidentally, the latch signal St supplied to the source driver 50 presents the horizontal scanning period used in the display operation including analog conversion and voltage application to the source bus lines.

The gate driver 60 selectively makes the gate bus line in the display panel 20 to be active in a manner according to the control signal Gc from the circuit 30, for example, selectively supplies a predetermined high voltage to the bus line. The active gate bus line makes the corresponding TFTs 21 to be turned on, and allows the TFTs 21 for the one line to be simultaneously driven by the source signals supplied to the TFTs 21. Accordingly, the pixels of the row corresponding to the active gate bus line are optically modulated in accordance with the pixel information of one line at one time. It is noted that the manner of control for the gate driver 60 by the control signal Gc from the circuit 30 will hereinafter be described in detail.

Now the operation of the matrix addressing circuit 10 is described.

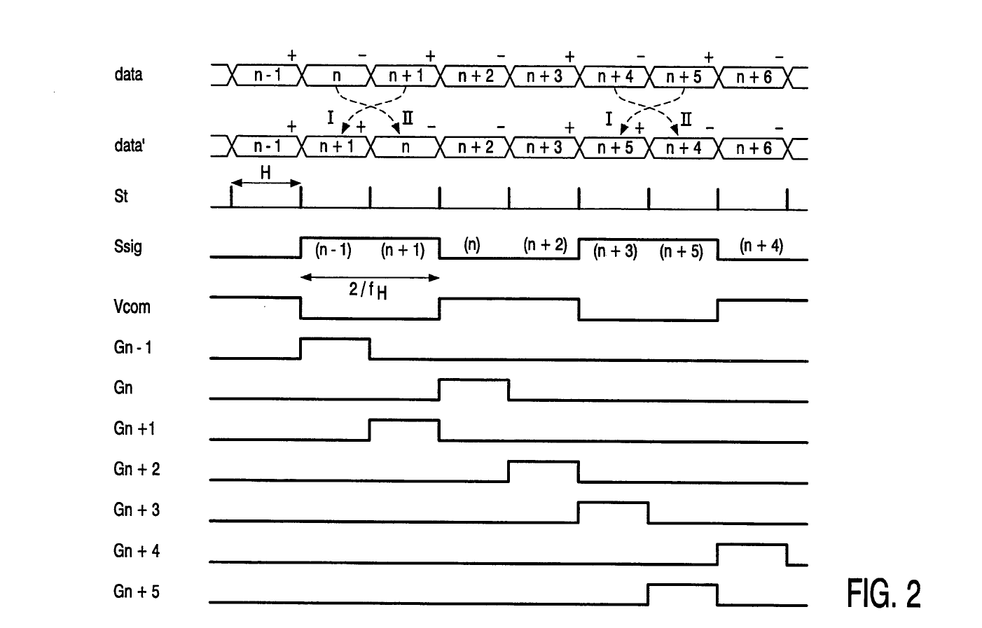

FIG. 2 schematically shows an operation of the addressing circuit 10 in time chart form.

As shown in FIG. 2, for the image data signal “data”, pixel data of the (n−1)-th line, pixel data of the n-th line, pixel data of the (n+1)-th line, . . . are sequentially transferred to the memory 40 as the line number is incremented from the upper row to the lower row in the display area of the display panel 20. The line-sequential image data train signal is stored in the memory 40 in the transferring order (namely, with keeping the line-sequence) for each line.

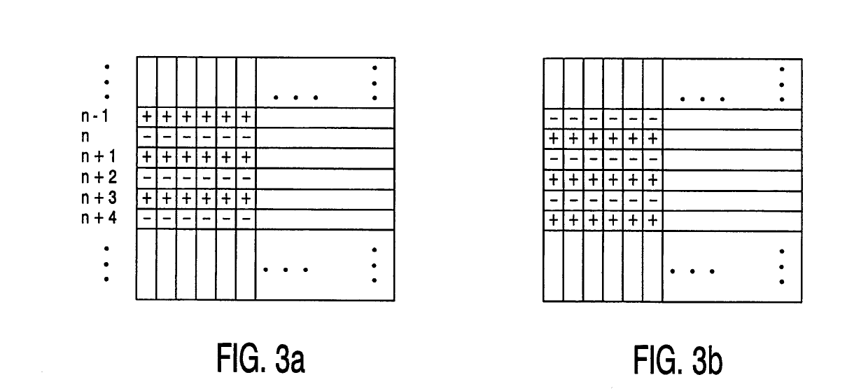

In the memory 40 the stored image data signals are read out with performing a time-series scanning process for them based on the control signal Mc from the circuit 30. This process is described in more detail using FIG. 3.

To begin with, the present embodiment is directed to the so-called line alternately driving operation as shown in FIG. 3. In this driving operation, as shown at (a) in FIG. 3, distribution of polarities alternating every row is intended on the display screen for one frame period of the image, for example, in such a manner that the pixels of the (n−1)-th line (row) are driven to a first polarity, i.e. positive, the pixels of the n-th line are driven to a second polarity, i.e. negative, the pixels of the (n+1)-th line are driven to positive, and so on. As shown at (b) in FIG. 3, distribution of polarities alternating every row is also intended on the screen for the next frame period of the image, for example, in such a manner that the pixels of the (n−1)-th line are driven to negative, the pixels of the n-th line are driven to positive, the pixels of the (n+1)-th line are driven to negative, and so on, but the respective rows are driven with the polarities different from those in the preceding frame. The one-line alternately driving is accomplished by alternate repetition of the driving pattern (a) and the driving pattern (b). The spatial polarity-inversion distributions on the screen shown in FIG. 3 themselves are the same as those in the prior art.

In the prior art, such a spatial manner of polarity-inversion of the pixels on the screen as described above is performed by making selection of a line sequentially from the top to the bottom of the screen while the pixel data corresponding to the selected line are supplied to the source driver so as to drive that line of pixels.

In contrast to this, the present embodiment, instead of the sequential line-selection from the top to the bottom of the screen, is intended to select lines of pixels to be at the same polarity in such a manner that the lines can be selected successively on a time series and to make the source driver 50 convert the corresponding pixel data to the analog source signal in accordance with the selected line and a polarity to be given to the selected line. The timing control and voltage producing circuit 30 produces the voltage Vcom applied to the common electrode 25 with a polarity which matches the given polarity.

As will be understood with reference to FIG. 3, the pixels for the (n−1)-th line and the pixels for the (n+1)-th line should be driven with the same polarity even when the frame is changed. In the same way, the pixels for the n-th line and pixels for the (n+2)-th line should be driven with the same polarity even when the frame is changed. Then the present embodiment is intended to exchange the pixel data between the n-th line and (n+1)-th line of the “data” sequence on time axis (see the dotted arrow) as shown in FIG. 2. In this way, as the “data′” sequence, the pixel data of the (n−1)-th and (n+1)-th lines that both are driven with one (+) of the polarities (e.g., positive) are rearranged to be made successive on a time series, and the pixel data of the n-th and (n+2)-th lines that both are driven with another (−) of the polarities (e.g., negative) are made successive on a time series, and the rearranged lines of data are supplied to the source driver 50.

Also, pixel data for the (n+4)-th and (n+5)-th lines in the “data” sequence are exchanged with each other on time base. The pixel data of the (n+3)-th and (n+5)-th lines to be both driven to the one (+) of the polarities are made successive on a time series. The pixel data of the (n+4)-th and (n+6)-th lines to be both driven to the other (−) of the polarities are rearranged to be made successive on a time series. Then, the rearranged lines of data are supplied to the source driver 50.

Such data manipulation is also executed for other later pixel data, and as a result the image data “data′” having the line order of n−1(+), n+1(+), n(−), n+2(−), . . . are obtained, as shown in FIG. 2. As will be understood from this, the pixel data to have the same polarities for the pixel voltages are collectedly outputted every two lines.

In order to perform the time-series operation as mentioned above, the memory 40 is read-controlled so that the pixel data for the respective lines are rearranged on a time series as described above. The source driver 50 updates and outputs the pixel data for one line from the memory 40, based on the latch signal St, i.e. the latch signal that has a valid level at intervals of the horizontal scanning period in this example, as well as in response to the change of the signal level to the valid level.

A source signal S_{sig} shown in FIG. 2 is based on the pixel data after the rearrangement, and is observed at any one of the source bus lines. In this example, the levels for the same black-displaying over the display screen are represented as the levels of the source signal S_{sig}. As will be understood from this, the source signal S_{sig} is based on sets of two lines of pixel data (the (n−1)-th and (n+1)-th line of pixel data, etc.) with the same polarity, and therefore it is inverted every two horizontal scanning periods (2H). Incidentally, in this example, the voltage V_{com} applied to the common electrode 25 is inverted in accordance with the polarity to be given for driving, whereby it is an alternating current voltage. Accordingly, the source signal S_{sig} is produced by the source driver 50 in such a manner that the source signal S_{sig} represents the black level suitable to the alternating current voltage. Consequently, the timing control and voltage producing circuit 30 inverts the common electrode voltage V_{com} every two horizontal scanning periods.

The gate driver 60 executes scanning in a manner commensurate with the source signals (i.e. pixel voltages) for lines outputted from the source driver 50. That is, the gate driver 60 produces gate control signals based on the control signal Gc from the timing control circuit 30 as follows. After a gate control signal Gₙ₋₁ for making the (n−1)-th line active is generated, a gate control signal Gₙ₊₁ for making the (n+1)-th line active is generated (not the n-th line spatially next to the (n−1)-th line), and thereafter a gate control signal Gₙ for making the n-th line active, and a gate control signal Gₙ₊₂ for making the (n+2)-th line active. The gate driver 60 applies a predetermined active driving voltage to the gate bus line suitable to the pixel voltages for each line applied from the source driver 50 in accordance with these gate control signals Gx.

It is thus better understood from FIG. 3 that the scanning is, so to speak, a line skip scanning, different from the line-sequence, in which the lines n−1(+), n+1(+), n(−) and n+2(−) . . . are scanned within the display area in this order.

In the structure and operation according to the present embodiment as mentioned above, the time-series operation (manipulation) is realized in which the pixel information supply and scanning for the lines to have the same polarity are made continuous on a time series, whereby the inversion period of the source signal S_{sig} and the voltage V_{com} applied to the common electrode can be prolonged. Incidentally, an arrow I in FIG. 2 indicates a first time-series operation for positive driving and an arrow II indicates a second time-series operation for negative driving. By the time-series operations and the scanning operation suitable thereto, the frequencies of the source signal S_{sig} and the voltage V_{com} applied to the common electrode are decreased and thus the power consumption can be reduced. Furthermore, since the distribution of reversed polarities for driving pixels on the display screen is not changed, the above-mentioned effects of the alternately driving in the prior art can be expected without change.

Next, a detailed description will be given of the advantages of reduction of the power consumption by virtue of decreasing the frequencies of the source signal and the voltage applied to the common electrode.

A current Is′ for charging and discharging the source bus line is expressed by the following formula.
Is′=Cs·V_{sig}·f′, (1)
where Cs denotes an equivalent capacitance of the source bus line, V_{sig} denotes an amplitude value of the voltage applied to the source bus line, and f′ denotes a frequency of charging and discharging the source bus line.

A current for charging and discharging the common electrode is expressed by the following formula.
Ic′=Cc·Vc·f′ (2)
, where Cc denotes an equivalent capacitance of the common electrode, Vc denotes an amplitude value of the voltage applied to the common electrode, and f′ denotes a frequency for charging and discharging the common electrode.

The alternation system according to the above-mentioned embodiment is directed to alternation every one line, which is the same as in the prior art. However, the frequency f′ is half of the horizontal scanning frequency f_{H} in the embodiment.

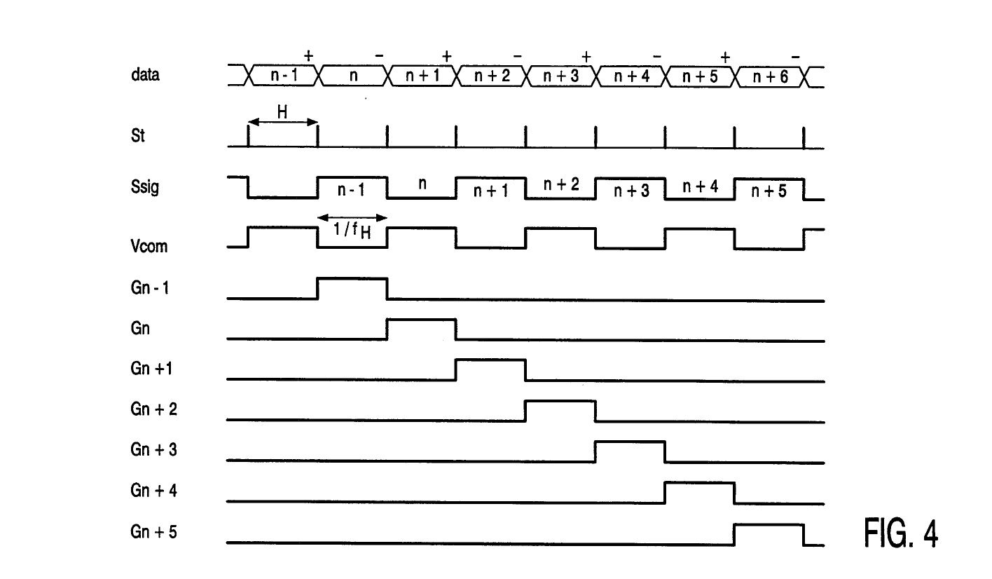

For comparison, FIG. 4 shows a time chart of the alternately driving operation every line in the prior art. As will be understood from this, since the “data” series is directly converted to analog signals and the converted signal is supplied to the source bus line, both the source signal S_{sig} and the voltage V_{com} applied to the common electrode are inverted every horizontal scanning period. Further, it is seen that the gate control signal Gx is produced in line-sequence.

Therefore, there is a relationship as follows.
f′=f_{H}/2 (3)

Assuming that V_{sig} is a fixed value V1 of the applied voltage and Vc is a fixed value V2 of the applied voltage, a power Ps′ for charging and discharging the source bus line and a power Pc′ for charging and discharging the common electrode can be expressed by the following formulae.

$$\begin{matrix}{Ps}^{′} = V1 \cdot {Is}^{′} & ( 4 ) \\ = V1 \cdot Cs \cdot {V}_{sig} \cdot {f}^{′} & \\ {Pc}^{′} = V2 \cdot {Ic}^{′} & ( 5 ) \\ = V2 \cdot Cc \cdot Vc \cdot {f}^{′} & \end{matrix}$$

As will be understood from the formula (3), the frequency according to the present embodiment is half, as compared with that in the prior art. Consequently, it is apparent that the powers obtained by the formulae (4) and (5) are respectively half as compared with that in the prior art.

According to the present embodiment, the number of lines to be made successive with the same polarity is 2, but it may be greater than 2. In this case, assuming that the number of lines to be made successive is N, the power consumptions for the source bus line and the common electrode are 1/N, respectively, as compared with the case of lines not to be successive with the same polarity in the prior art (see FIG. 4).

How to make the lines successive with the same polarity and the scanning order of lines may be considered in various styles.

For purpose of simple description, an assumption is given in which the lines are numbered 1, 2, 3, . . . , from the top of the display screen downward and in which alternately driving is performed for every line. In this assumption, according to the embodiment as shown in FIG. 2, the lines are aligned in order of 1, 3, 2, 4, 5, 7, 6, 8, . . . . This embodiment is intended to make two lines with the same polarity to be successive, the lines being spatially rather close to each other. It would be a simpler solution.

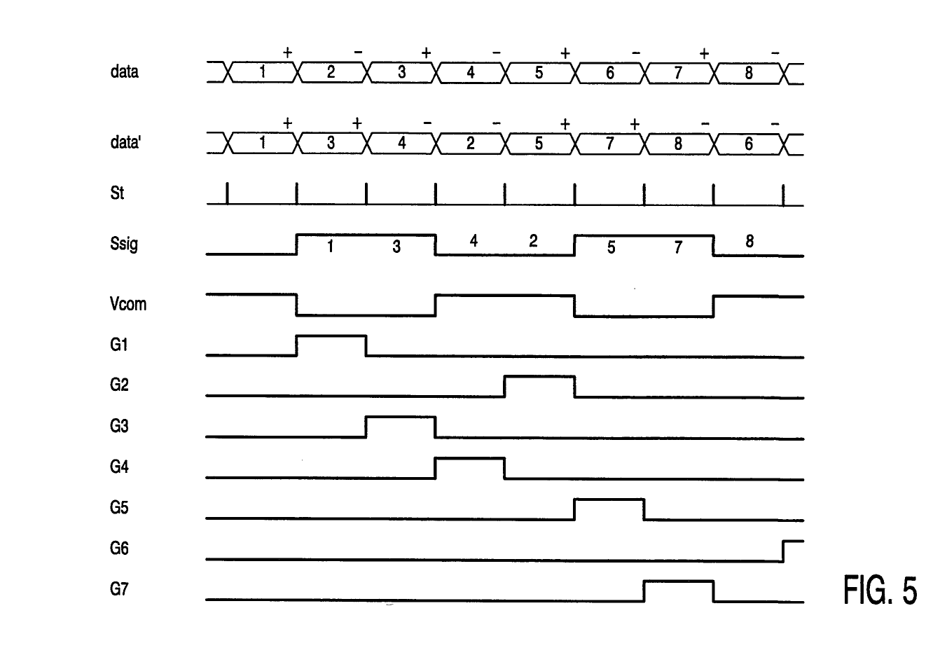

Referring to FIG. 5, according to one modification of the embodiment, the lines may be aligned in order of 1, 3, 4, 2, 5, 7, 8, 6, . . . . In addition to the condition that the two lines with the same polarity, which are spatially rather close to each other, are made successively aligned, a condition is further given in which the scanning is performed in such a manner that a preceding line to be given one polarity and a line spatially upward adjacent to the preceding line in a display screen, that is to be given the other polarity are not made successive to and are separated from each other on a time series.

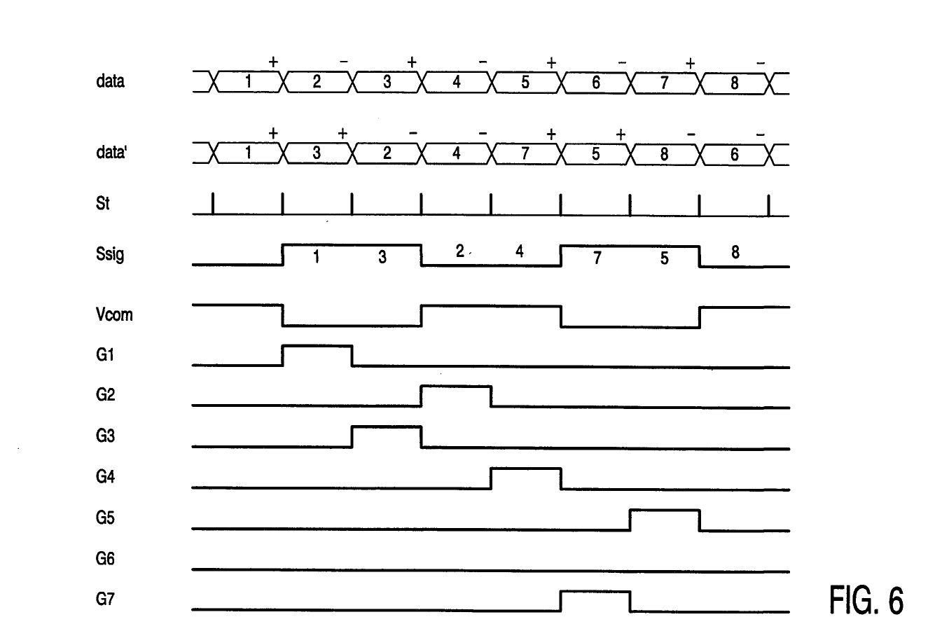

Referring to FIG. 6, according to the other modification of the embodiment, the line order of 1, 3, 2, 4, 7, 5, 8, 6, . . . can be realized. In addition to the condition that the two lines with the same polarity, which are spatially rather close to each other, are made successively aligned, a condition is given in which the scanning is performed in such a manner that a preceding line to be given one polarity and a line spatially downward adjacent to the preceding line in a display screen, that is to be given the other polarity are not made successive to and are separated from each other on a time series.

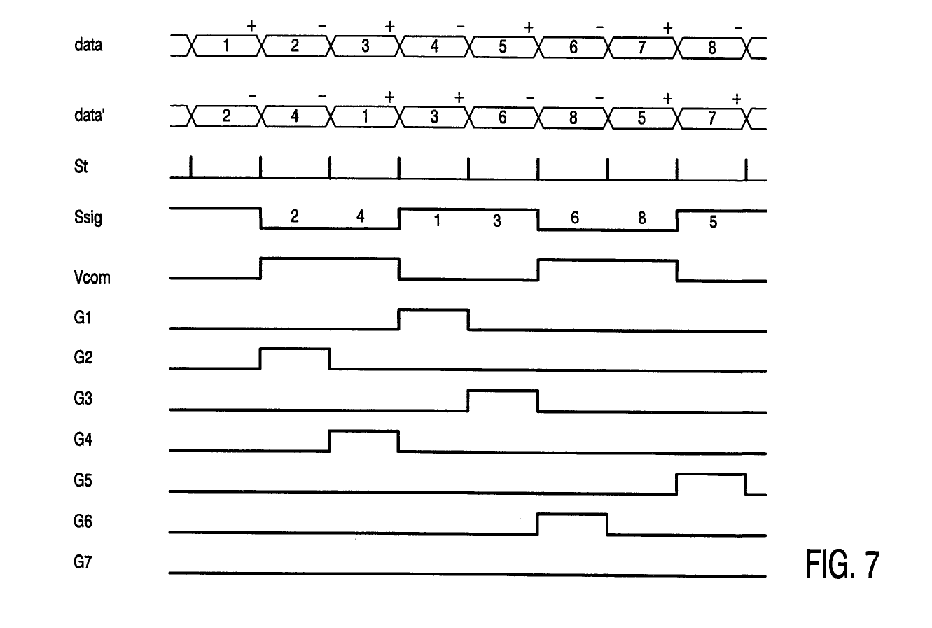

Referring to FIG. 7, according to a further modification of the embodiment, the line order of 2, 4, 1, 3, 6, 8, 5, 7, . . . can be realized. In addition to the condition that the two lines with the same polarity, which are spatially rather close to each other, are made successively aligned, a condition is given in which the scanning is performed in such a manner that a preceding line to be given one polarity is not made successive to and is separated from the lines spatially upward and downward adjacent to the preceding line in a display screen, that are to be given the other polarity, on a time series.

As a result of comparison of the above-mentioned modifications, the operation styles according to the modifications in FIGS. 5 and 6 are more preferable than that in FIG. 2. Further, the style according to the modification in FIG. 7 is more preferable than those in FIGS. 5 and 6.

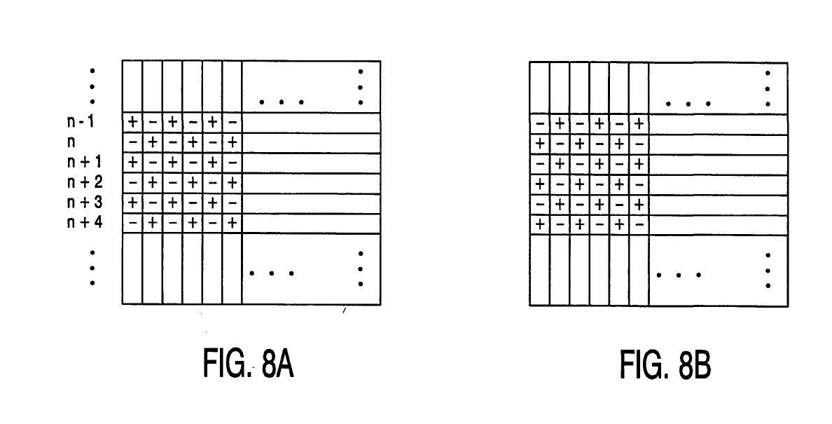

The typical embodiments and modifications thereof have been described, but the present invention is not limited to these and one can find variously modified examples. In addition to the one-line alternately driving system, the present invention will be applied to a two-or-more-line alternately driving system. Furthermore, the present invention can be applied to the so-called dot alternately driving system in which the polarities of the pixels spatially adjacent in all four directions are changed in a display screen. FIG. 8 shows driving patterns of a dot alternately driving system. Referring to FIG. 8, by the operation as shown in FIG. 2, the polarity inverting rate is reduced on a time series, and it is possible to obtain the same effects and advantages as those according to the above embodiments.

Moreover, the present invention can appropriately be modified by those skilled in the art without departing the protection scope of the claims.

1. A matrix addressing method for alternately driving pixels arranged in matrix, wherein:
a plurality of row electrodes extending in a horizontal direction of a display screen are made to be selectively active for each horizontal scanning period of images to be displayed;
a plurality of column electrodes extending in a vertical direction of the display screen are applied with respective pixel voltages that are responsive to the image and correspond to the horizontal scanning period while the pixel voltages have polarities alternating for each frame period of the images; and
the pixel voltages have polarities alternating in the vertical direction spatially in a display area within the frame period,
the method including:
successively sequencing on a time series an application timing of the pixel voltages for one row electrode and an application timing of the pixel voltages for the other row electrode, the pixel voltages for the other row electrode being to be in the same polarities as the pixel voltages for the one row electrode; and
activating the corresponding row electrode in response to each of the application timings of the pixel voltages for the one and the other row electrodes.

2. A method as defined in claim 1, characterized by a first time-series operation process and a second time-series operation process each of which is carried out at least once,
the first time-series operation process being a process whereby an application timing of the pixel voltages for one row electrode to be given the first polarities and an application timing of the pixel voltages for the other row electrode to be given the first polarities are in succession,
the second time-series operation process being a process whereby an application timing of the pixel voltages for further one row electrode to be given the second polarities different from the first polarities and an application timing of the pixel voltages for the other row electrode to be given the second polarities are in succession,
wherein the corresponding electrode is activated in response to each of the application timings of pixel voltages for the row electrodes.

3. A method as defined in claim 1, characterized in that the pixel voltages have polarities that alternate in the vertical direction spatially in a display area within the frame period in units of at least one row electrode.

4. A method as defined in claim 1, characterized in that the pixel voltages have polarities that alternate in the horizontal direction spatially in a display area within the frame period in units of at least one column electrode.

5. A method as defined in claim 2, characterized in that in the first and second time-series operation processes, an application timing of pixel voltages for a preceding row electrode to be given first polarities is separated on a time series from an application timing of pixel voltages for a further row electrode to be given the other polarities, the further row electrode adjoining upward to the preceding row electrode spatially in a display area within the frame period.

6. A method as defined in claim 2, characterized in that in the first and second time-series operation processes, an application timing of pixel voltages for a preceding row electrode to be given first polarities is separated on a time series from an application timing of pixel voltages for a further row electrode to be given the other polarities, the further row electrode adjoining downward to the preceding row electrode spatially in a display area within the frame period.

7. A method as defined in claim 2, characterized in that in the first and second time-series operation processes, an application timing of pixel voltages for a preceding row electrode to be given first polarities is separated on a time series from an application timing of pixel voltages for a further row electrode to be given the other polarities, the further row electrode adjoining to the preceding row electrode spatially in a display area within the frame period.

8. A matrix addressing circuit for alternately driving pixels arranged in matrix, wherein:
a plurality of row electrodes extending in a horizontal direction of a display screen are made to be selectively active for each horizontal scanning period of images to be displayed;
a plurality of column electrodes extending in a vertical direction of the display screen are applied with respective pixel voltages that are responsive to the image and correspond to the horizontal scanning period while the pixel voltages have polarities alternating for each frame period of the images; and
he pixel voltages have polarities alternating in the vertical direction spatially in a display area within the frame period,
the matrix addressing circuit comprising:
time-series operating means for successively sequencing on a time series an application timing of the pixel voltages for one row electrode and an application timing of the pixel voltages for the other row electrode, the pixel voltages for the other row electrode being to be in the same polarities as the pixel voltages for the one row electrode; and
row driving means for activating the corresponding row electrode in response to each of the application timings of the pixel voltages for the one and the other row electrode.

9. A matrix addressing circuit as defined in claim 8, characterized in that:
the time-series operating means comprise: a memory for storing a data train signal representing the corresponding pixel voltages for each of pixel information blocks each corresponding to a row electrode; and a control circuit for executing reading out control of the memory,
the control circuit controlling the reading of the memory to produce a modified data train signal in such a form that application timings of pixel voltages for one row electrode and of pixel voltages for the other row electrode to be given the same polarities as those of the pixel voltages for the one row electrode are successively sequenced on a time-series, from the data train signals stored in the memory,
the row driving means are arranged to produce a row driving signal for activating the corresponding row electrode in response to each of the application timings of the pixel voltages for the one and the other row electrodes in harmony with the modified data train signals.

10. An addressing circuit as defined in claim 8, characterized in that the addressing circuit is arranged to drive an active matrix type display device comprising: pixel drive elements provided in association with pixels, whose control inputs are coupled with the row electrodes and whose signal inputs are coupled with the column electrodes; and a common electrode disposed facing pixel electrodes coupled to the pixel drive elements, and
the addressing circuit further comprises voltage producing means for producing a driving voltage signal to be applied to the common electrode, the driving voltage signal having polarity alternation adapted to the polarities to be given to the corresponding pixel voltages in response to each of the application timings of the pixel voltages for the one and the other row electrodes.

11. A liquid crystal display device using a matrix addressing circuit as defined in claim 8.
